(19) United States
(12) Patent Application Publication
(10) Pub. No.: US 2003/0063868 A1
(43) Pub. Date: Apr. 3, 2003

(54) Fiber optic cable termination devices and methods

(76) Inventor: Vernon Fentress, Springfield, VA (US)

Correspondence Address: HANDAL & MOROFSKY, 80 WASHINGTON STREET, NORWALK, CT, 06854, US

(21) Appl. No.: 10/226,092

(22) Filed: Aug. 22, 2002

Related U.S. Application Data
(63) Continuation-in-part of application No. 09/788,937, filed on Feb. 20, 2001.
(60) Provisional application No. 60/183,196, filed on Feb. 17, 2000.

(51) Int. Cl. G02B 6/36; G02B 6/38

(52) U.S. Cl. 385/78; 385/60

(57) ABSTRACT

A fiber optic cable connector device capable of coupling fiber optic cables for use in installing a fiber optic cable network including a cap member having an for receiving and securing a fiber optic cable end portion, a sleeve member having a retaining device to receive, engage and secure the cap member containing a fiber optic cable end portion, and a coupling member having a retaining device to receive, engage and secure the assembled fiber optic cable end portion, sleeve and cap members. An adapter, having fiber conduit slidably mounted within a support member housing, provides an interface for coupling multiple single-fiber carrying fiber optic cables and dual fiber carrying fiber optic cables. A method of terminating fiber optic ends with little or no polishing permits viewing of the illuminated fiber end-face through a microscope while adjusting the position in a the ferrule. The method enables employment of a commercial cleaving machines to cleave the fiber and avoids significant material removal from the fiber when mounted in the ferrule. A novel cable termination device is also included.

### CROSS-REFERENCE TO RELATED APPLICATIONS

This application is a continuation-in-part of copending U.S. patent application Ser. No. 09/788,937 of Fentress, filed Feb. 20, 2001 and entitled “ADAPTER METHOD AND PULL PROTECTOR FOR FIBER OPTIC CABLE” which application claims benefit of Provisional Patent Application No. 60/183,196, filed Feb. 17, 2000. The entire disclosure(s) of the aforementioned U.S. patent application Ser. Nos. 09/788,937 and 60/183,196 are hereby incorporated herein by reference thereto as though wholly set forth herein.

### BACKGROUND OF THE INVENTION

1. Field of the Invention

The present invention relates to a new and improved method and apparatus for installing fiber optic cables. More particularly, the invention relates to an inventive method of aligning fibers and fiber end-faces to eliminate the need for polishing, and inventive improvements in fiber optic cable components, such as adapters, connectors, coupling assemblies and pull protectors, to provide high quality termination of fiber optic cables and ease of cable installation in the field.

2. Description of Related Art Including Information Disclosed under 37 CFR 1.97 and 37 CFR 1.98

Typically, fiber optic cables installed in or between buildings to enable intra-organizational data and telephone communications are housed in conduits and connected with de-matable connectors. The benefits of fiber optics for use in these local networks are many. However, the primary benefit lies in the ability to send the information of many telecommunication instruments over an exceedingly small number of channels as compared to conventional copper cables. A single pair of optical fibers may, in fact, replace several hundred pairs of copper cables.

Fiber optic cables are desirable because of a need for high capacity small cables, especially where conventional copper or coaxial cables of equivalent capacity will not fit, e.g., in small or congested cable ducts. Copper or coaxial cable bundles as large as 100 mm in diameter can be avoided in favor of fiber optic cables as small as 3 mm in diameter.

However, single channel de-matable fiber optic connectors which are used to terminate the cable are typically 8 to 20 millimeters in diameter. This results in a connector bundles having diameters much larger then the cable diameters. For example, a typical AT&T Technologies connector used to terminate a typical 6 channel, 8 mm diameter, fiber optic cable will result in a bundle size of 36.7 mm, which is over four (4) times the size of the cable. The National Electrical Code limits a single cable to 53% of the conduit area. Thus, the 8-mm cable can easily fit a standard ½-inch conduit. The same cable with pre-installed connectors would require a 1½ inch standard conduit just to clear the connector bundle. Pulling equipment may dictate an even larger size conduit. Furthermore, the existence of previously installed cable and/or a series of 90-degree conduit bends might raise the required conduit size even higher. To compound these problems, the typical cable grip used to install cables in conduits does not expand to a size greater than a small percentage larger than the minimum allowable cable diameter, i.e., it will not fit over a connector bundle with a diameter greater than a small percentage larger than the diameter of the cable. Recently new plastic pull protectors have been developed, which allow the pull of larger bundles. However, these larger bundles cannot be pulled through most electrical ducts because of their larger diameter.

This situation has almost universally resulted in field termination (as opposed to the more desirable factory termination) of duct-installed fiber optic cables. Installing the typical epoxy and polish connector is time-consuming, and takes approximately 20 to 40 minutes per end (two ends per connection) requiring approximately 40 separate steps. For example, some of these required steps include: (1) stripping the jacket away from the cable; (2) folding back the fabric strength member material (typically formed of KEVLAR® synthetic fiber E. I. du Pont de Nemours and Company) and stripping the buffer material; (3) cleaving or putting a break in the fiber such that the break is perpendicular to the axis of the fiber; (4) cementing the fiber inside of the connector with epoxy; and (5) polishing the fiber optic connector. The connectors may each cost as much as $10.00 or more. An incorrect installation or accidental breakage of the fragile fiber may necessitate that the connector be cut off, discarded and a new installation procedure begun, necessitating repeating all of the tedious steps, including that of polishing the connector, which is perhaps the most time-consuming. As a result, highly skilled personnel are typically required to perform field installation of de-matable connectors.

My U.S. Pat. No. 5,253,315, addressed this issue by disclosing a universal connector body provided with the capability of mating with most existing connectors on the market. A universal inner housing is provided which mates with a wide variety of coupling nut assemblies or adapters, allowing these coupling nut assemblies or adapters to mate with the universal connector body. The connector body design has the fiber terminated to a precision tip, which is spring-loaded within the housing to which the strength member is terminated to prevent interruption of the optical signal if the cable is pulled or otherwise disturbed. This design also provides for the take-up of slack buffered fiber due to the retraction of the spring-loaded tip. The manner in which the universal connector body mates with the universal inner housing provides a method of indexing the rotation of the connector body, allowing it to be tuned as to insertion loss upon installation or thereafter. The inner housing is compatible with a wide variety of connector adapters, including ST, SC, FC, D4, and high-density types.

The termination of the connector body to an optical fiber is facilitated by its unique design, which greatly simplifies the process as compared to conventional pull-proof connectors. The connector body may be terminated for pulling through a building duct by employing a unique process and a special pull boot described in this patent.

However, certain aspects of my disclosure U.S. Pat. No. 5,253,315 may be improved upon. The method of interchanging the coupling nut assemblies or adapters requires a special tool. The assembly of the universal connector body does not lend itself well to the incorporation of 900 um cable designs, and the pull protector requires a complicated housing.

Accordingly, I have invented a new and improved universal connector body, adapter and pull protector method which provides for the interchange of adapters without a tool, facilitates the incorporation of 900 um cable designs, and provides a simplified and pull protector that is relatively easier to use.

When attaching fiber optic cables to communications systems it is necessary to terminate them with fiber optic connectors. Fiber optic connectors position the fiber ends of the fiber optic cable to receive or transmit light. The surfaces of the fiber ends must be smooth and perpendicular to the fiber axis for greatest efficiency in accepting light rays. In addition, for low-loss terminations, care must be taken to preserve the domed profile of the connector ferrule or prepare the fiber such that is has a slight protrusion. Rough or dirty end surfaces block and scatter light.

The conventional method of terminating an optical fiber involves the application of epoxy and polishing with a variety of grinding papers and solutions. The objective is to polish the optical fiber end-face flat and smooth, while preserving the domed profile of the connector ferrule. This glue and polish practice is wide-spread, although it has been found to provide acceptable results, such results vary depending upon the skill of the operator.

The typical steps of the conventional means to terminate fiber optic connectors onto a fiber optic cable include approximately 43 steps as follows:

Gather all materials (fiber cable, connectors, epoxy, syringes, polishing film, fiber disposal bin, and toolbox). Place everything on the table in a convenient location. Open connector package and lay-out all parts. Do not take dust cap off the connector ferrule yet.

Prepare the cable. Push rubber strain relief boot about 4 inches up the cable. Push the crimp ring up the cable to the boot (make sure it is on in the right direction). Strip a length of jacket from the fiber, depending upon the specific connector type. Cut the KEVLAR® fabric strength member to some length depending upon the specific connector type. Strip the buffer ¼″ at a time until some length of fiber is exposed, depending upon the specific connector type. Clean the fiber.

Prepare/Apply epoxy. Place needle on syringe to receive the epoxy. Mix epoxy. Pour into syringe. Replace plunger. Hold upright and slowly get air out of syringe. Select connector. Remove dust cap from connector. Push syringe all the way into connector. Push in plunger to inject epoxy until a bead appears on the end of the ferrule of the connector. Pull the syringe halfway out of the connector and fill the backshell with epoxy carefully. Insert the fiber into the connector and carefully work it through the ferrule, twisting the connector as you go, until the fiber is in as far as possible. Insure that you have a good-sized bead of epoxy on the tip of the ferrule.

Push the crimp sleeve up, capture the KEVLAR® fabric strength member and crimp it to the back-shell of the connector. Crimp the back of the crimp sleeve to the cable. Push the boot over the crimp sleeve. Wipe off excess epoxy from the protruding fiber. Be careful not break off the fiber or remove the epoxy bead at the tip of the ferrule. Fiber breakage at this point could make connector unusable.

Cure the epoxy. Cure only until the bead of epoxy is hardened. The epoxy inside the ferrule will cure fully at room temperature in less than 24 hrs.

Cleave and polish using the following steps: Gather up tools and supplies. Set up polishing plate with 3 and 0.3 micron lapping film (the connector is ready for cleaving and polishing when the epoxy bead on the tip is hardened), cleave the fiber, using 15 micron film, “Air Polish” to remove most of the protruding fiber and epoxy bead, and air polish with 12 micron film to remove burr and most of the epoxy bead. Put connector in polishing puck. Lay gently on 3 micron film. Polish with a figure 8 motion until epoxy bead is gone and it gets “slippery”. Wipe off. Polish a few figure “8's” on 3 micron film. Clean.

Test. View in microscope. Test for loss.

These steps must be carefully followed and checked by experienced persons in order to achieve acceptable results. An alternative to this 43-step termination method is to use less durable termination processes with lower environmental performance. Alternatively, much more expensive connectors can be used which may eliminate some of these termination steps.

There exists a need to improve this method cheaply and efficiently, in that regard, I have invented an apparatus and method for the termination of optical fiber connectors with little or no polishing. This device and method produces consistent, low-loss terminations with considerably less effort that the 43-step method and using conventional inexpensive connectors. Also, this device and method preserves the domed profile of the connector ferrule and enables preparation of the fiber such that is has a slight protrusion if desired. Furthermore, this device and method has been found to yield the best fiber contact between mating connectors and, therefore, the lowest loss and back reflection.

The entire disclosure of each patent and patent application cross-referenced or referenced herein and of each non-patent publication referenced herein is hereby incorporated herein by reference thereto, as though fully set out herein. Each document incorporated by reference in any of the foregoing patents, patent applications or non-patent publications is also incorporated herein in its entirety by reference thereto.

### SUMMARY OF THE INVENTION

A new and improved apparatus and method for installing fiber optic cables, resolving the deficiencies of past systems, is disclosed herein. The inventive system serves to simplify the process of installing fiber optic cables and reduce the associated installation and equipment costs.

The inventive components comprise a new and improved universal connector body capable of securing a fiber optic cable and being mated with a new and improved coupling nut assembly or new and improved adapter. The universal connector body has an inventive retaining device to capture and secure receiving devices on the coupling nut assembly or adapter. The inventive components are also suitable for mating with existing connectors on the market.

The present invention also provides for capturing and securing a spring-loaded cap or ferrule assembly within the inventive universal connector body housing, which may then be captured and secured in an inventive coupling nut assembly, thus preventing separation of the terminated ends of fiber within the components.

The present invention further provides a new and improved pull-protector apparatus for protecting one or more pre-terminated universal connector bodies while being pulled through a duct or conduit during installation of a communications system.

The present invention further provides a new and improved apparatus and method for aligning the fiber optic connector end-face while terminating the fibers. An inventive positioning apparatus and method provides a view of the precise location of the fiber optic fiber with respect to the fiber optic connector end-face, thus enabling a technician to properly align the fiber optic fibers in the fiber optic connector while cementing material is setting. The resulting termination is characterized by optimal positioning of the fiber and a very low insertion loss and back reflection, thus minimizing or even eliminating the time-consuming step of polishing connector end-faces for both multimode and single-mode terminations.

An inventive adapter for adapting different connector and fiber optic cable formats. In particular, the inventive adapter is useful for connecting the 2.5 mm diameter type, characteristic of the ST, FC and SC connector interfaces or other connector types, to duplex connector formats with closely-spaced fibers, like the 0.75 millimeter fiber separation of the MT-RJ connector or other industry standard fiber optic simplex and duplex connectors. The inventive adapter allows for immediate interfacing of other connector formats to duplex fiber optic connectors with closely-spaced fibers without employing expensive jumper cables.

### BRIEF DESCRIPTION OF THE DRAWINGS

Some embodiments of the invention, and of making and using the invention, as well as the best mode contemplated of carrying out the invention, if not described above, are described in detail below, by way of example, with reference to the accompanying drawings, in which like reference characters designate the same or similar elements throughout the several views, and in which:

FIG. 1 is a diagram useful to explain the assembly process showing the ferrule assembly being captured by the new and improved universal connector body housing, which in turn, is sliding into a new and improved coupling nut assembly or adapter;

FIG. 2 is a cross-section of a fiber optic cable with a fiber stripped and prepared for termination to the ferrule assembly of the present invention;

FIG. 3 is a cross-section of the ferrule and universal connector body housing with a fiber optic cable in place, prior to the ferrule and universal connector body housing being engaged;

FIG. 4 is a top view of the ferrule and universal connector body housing with a fiber optic cable in place, after the ferrule and universal connector body housing have been engaged;

FIG. 5 is a cross-section of the inventive pull-protector, showing the attachment of two terminated ferrule and universal connector body housing assemblies with the pull-protector;

FIG. 6 is a cross-section of the inventive pull-protector of FIG. 5, illustrating the configuration of the two terminated ferrule and universal connector body housing assemblies while attached to and being pulled by the inventive pull-protector;

FIG. 7 is a cross-section of a terminated ferrule and universal connector body housing assembly and inventive coupling nut assembly, prior to the engagement of the ferrule and connector assembly;

FIG. 8 is a cross-section of the terminated ferrule and universal connector body housing assembly and inventive coupling nut assembly of FIG. 7, after engagement of the ferrule and universal connector body housing assembly;

FIG. 9 is a diagram useful to explain the assembly process of a second embodiment of the present invention, in which a ferrule assembly is captured by an alternative method and alternative embodiment of the inventive universal connector body housing;

FIG. 10 is a cross-section of the ferrule and fiber optic cable of the present invention being terminated onto a stripped fiber optic cable in accordance with the alternative method;

FIG. 11 is a cross-section of the ferrule and universal connector body housing assembly with a fiber optic cable in place, after the assembly has been engaged, in accordance with the second embodiment illustrated in FIG. 9;

FIG. 12 illustrates the attachment of the two terminated ferrule and universal connector body housing assemblies of FIG. 9 with the inventive pull-protector;

FIG. 13 illustrates the configuration of the two terminated ferrule and universal connector body housing assemblies of FIG. 9 while attached to and being pulled by the pull-protector;

FIG. 14 is a cross-section of the terminated ferrule and universal connector body housing assembly in accordance with the second embodiment, and inventive coupling nut assembly, prior to the engagement of the ferrule and universal connector body housing assembly;

FIG. 15 is a cross-section of the terminated ferrule and universal connector body housing assembly in accordance with the second embodiment, and inventive coupling nut assembly, after the engagement of the ferrule and universal connector body housing assembly;

FIG. 16 is an illustration useful for explaining the inventive termination method of optical fiber connectors with little or no polishing;

FIG. 17 is an illustration useful for explaining the viewing procedure for determining the fiber end-face position relative to the connector ferrule end-face and fiber protrusion δ;

FIG. 18 illustrates the inventive adapter and method for use with the disclosed inventive components or other standard fiber optic formats;

FIG. 19 is a schematic plan view of a cable termination work area according to the invention;

FIG. 20 is a cross-sectional view of a fiber optic cable which can be terminated by a method according to the invention;

FIG. 21 is a block flow diagram of a cable termination method according to the invention, which method can be performed at the cable termination work station shown in FIG. 19, if desired;

FIG. 22 illustrates a step in the method of the invention shown in FIG. 21 wherein a stripped cable is tested for play;

FIG. 23 illustrates another embodiment of universal connector housing useful in the method shown in FIG. 21;

FIG. 24 illustrates the assembly of the universal connector housing shown in FIG. 23 with a cable such as that shown in FIG. 20 pursuant to the method shown in FIG. 21;

FIG. 25 is a side elevational view of the assembled universal connector housing and cable shown in FIG. 24, with the cable buffer partially stripped back and pulled out a small distance;

FIG. 26 is a view similar to FIG. 25 with the buffered cable pushed in;

FIG. 27 illustrates a preferred manner of coating the stripped cable shown in FIGS. 25-26, with adhesive;

FIG. 28 is a schematic side elevational view of the cable shown in FIG. 27 mounted in a ferrule at a cable termination station pursuant to the inventive cable termination method;

FIG. 29 is a perspective view of a connector assembly step in the inventive cable termination method;

FIG. 30 is a perspective view of a ferrule being assembled with a universal connector housing in the inventive cable termination method;

FIG. 31 is a perspective view of a connector assembly step in the inventive cable termination method;

FIG. 32 is a side elevational view of a first shrink tube boot installation step in the inventive cable termination method;

FIG. 33 is a side elevational view of a second shrink tube boot installation step in the inventive cable termination method;

FIG. 34 is a side elevational view of a group of cable connector assemblies;

FIG. 35 is a side elevational view of a group of cable connector assemblies and a pull protector;

FIG. 36 is a side elevational view of a group of cable connector assemblies drawn into a pull protector with a pull protector rope in one configuration; and

FIG. 37 is a side elevational view of a group of cable connector assemblies drawn into a pull protector with a pull protector rope in another configuration.

### DESCRIPTION OF THE PREFERRED EMBODIMENTS

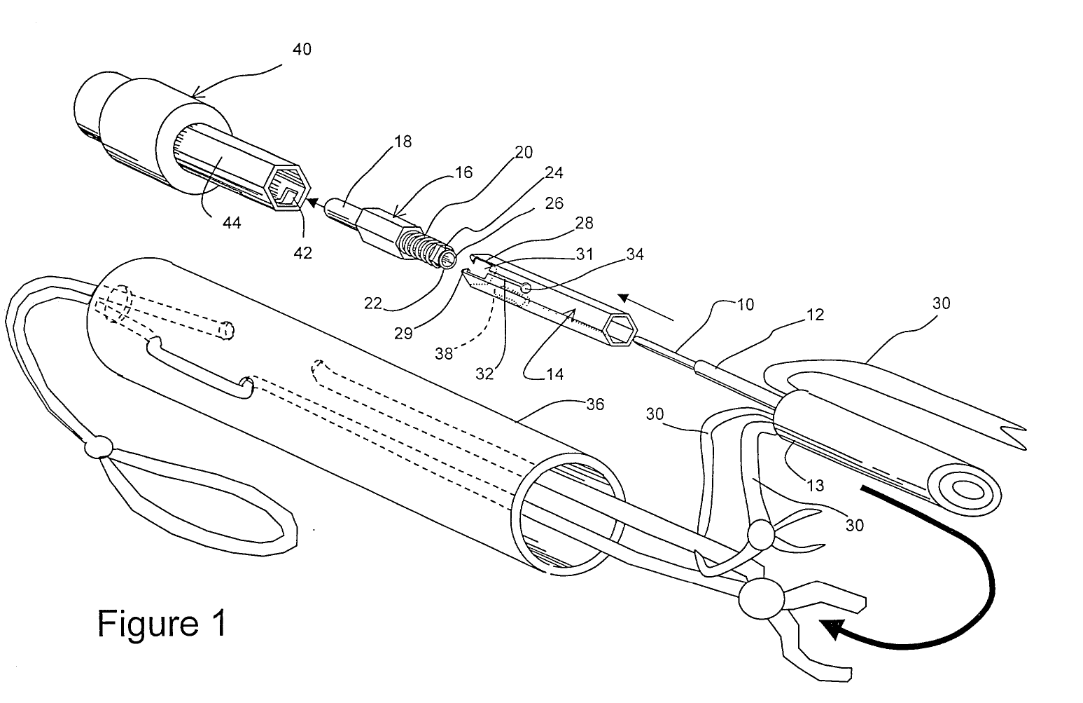

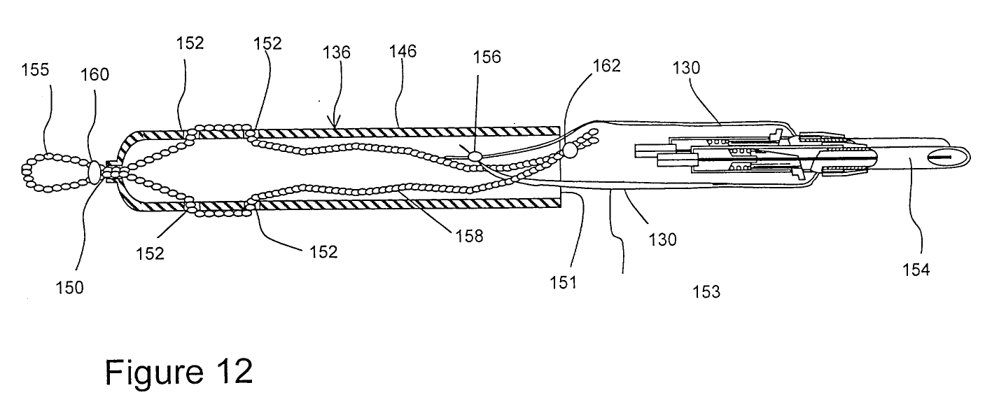

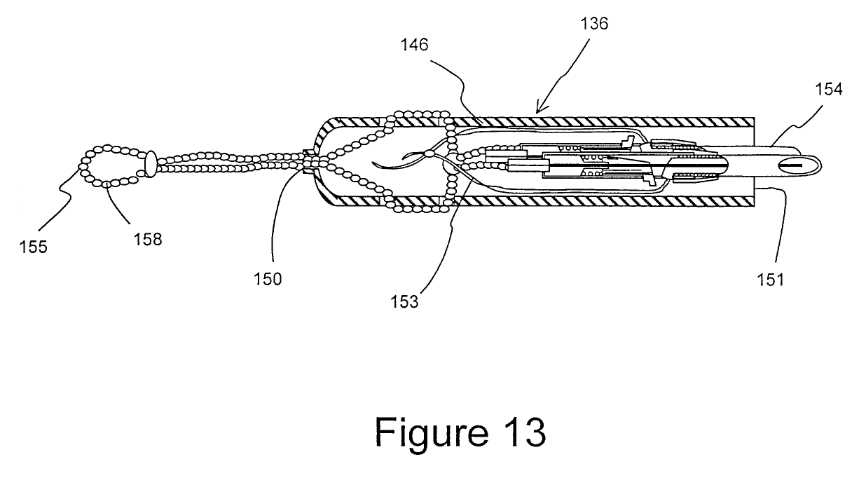

Reference is made to FIGS. 1-18 of the drawings in detail, which show the assembly and installation procedure for the new and improved universal connector body.

Referring to FIG. 1, fiber 10 from fiber optic cable 12 is inserted through universal connector body housing 14, and engaged by a ferrule 16 having a hollow ceramic tip 18. A spring 20 is disposed over a length of hollow tube 22 having a protruding member 24 proximate to opening 26 in the hollow tube 22. Protruding member 24 secures spring 20 on tube 22, and functions to connect the body housing 14, as will be discussed below.

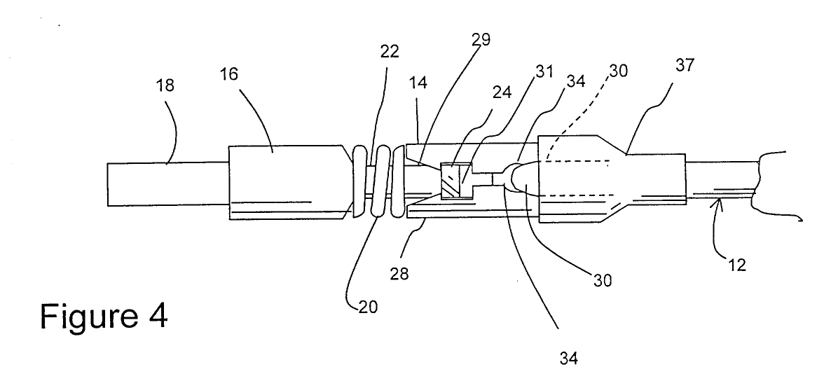

Ferrule 16 is connected with connector body housing 14 by a retaining device. In this embodiment, the retaining device comprises inserting protruding member 24 into gripping device 28 on a universal connector body housing 14, as illustrated in FIG. 4. Gripping device 28 has ramps 29 which are slanted to allow member 24 to be easily inserted into and locked into position but not easily removed from opening 31. Opening 31 is configured to engage member 24 upon its insertion.

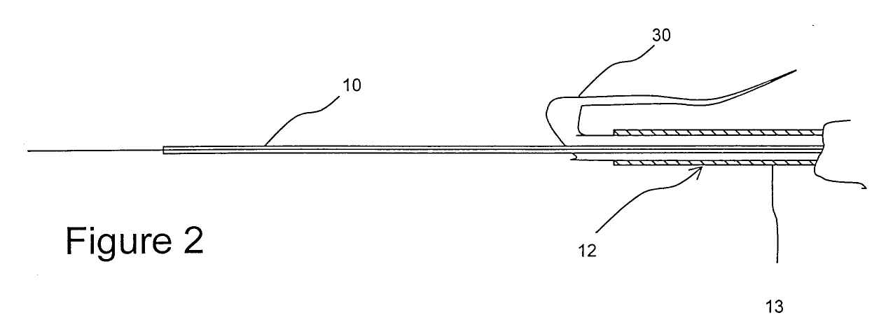

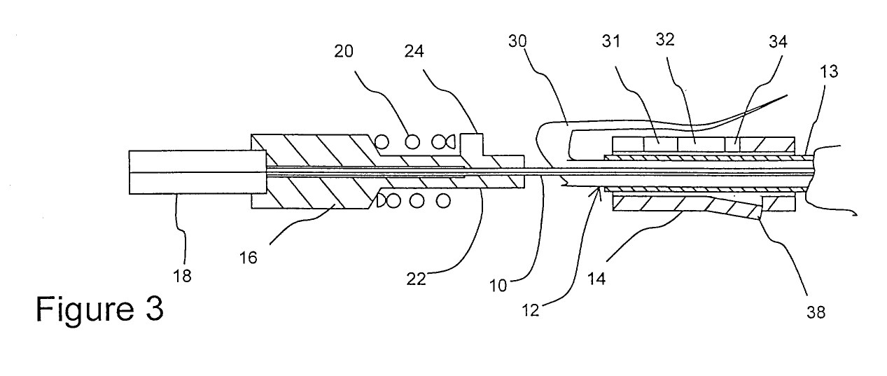

FIG. 3 illustrates fiber 10 inserted through ferrule 16 and connector body housing 14 just prior to member 24 being engaged by gripping device 28 and KEVLAR® fabric strength member ends 30 being set through opening 34. The universal connector body housing 14 is installed over the fiber optic cable 12 before the termination process. Ripped open and pulled away KEVLAR® fabric strength member sheath ends 30 surrounding fiber 10 and are pulled away from cable 12 after fiber 10 and KEVLAR® fabric strength member 30 is inserted through ferrule assembly 16. Cable 12 also has an exterior casing 13, which is typically made of PVC or plastic material. FIG. 2 illustrates fiber optic cable 12 being stripped of casing 13 to expose strength member 30 and fiber 10. When cable 12 is passed through connector body housing 14 and retaining device 29 is engaged, ferrule 16 is secured to housing 14. Separated strength member ends 30 are slipped through opening 31 into slot 32 and finally into opening 34. Opening 34, slot 32 and opening 31 are cut in universal connector body housing 14. Strength member ends 30 are exposed to a sufficient length to enable their attachment to a pull protector 36.

As shown in FIG. 4, the strength member ends 30 and universal connector body housing 14 may be fixed to cable 12 by using an adapter tube 37, which is placed over cable 12 before cable 12 is connected to ferrule 16. Adapter 37 has an end configured to engage housing 14 and an opposing end configured to engage cable 12. Preferably, adapter tube 37 is filled with adhesive prior to it being installed on housing 14 and cable 12. A latch 38 (FIG. 3) on universal connector body housing 14 secures housing 14 on coupling nut assembly 40 as shown, or an adapter, by engaging slot 42 (FIG. 1) in receiving tube 44 on coupling nut 40, as shown in FIG. 1. Housing 14 would be installed in coupling nut 40 once the fiber 10, ferrule 16 and housing 14 are assembled together.

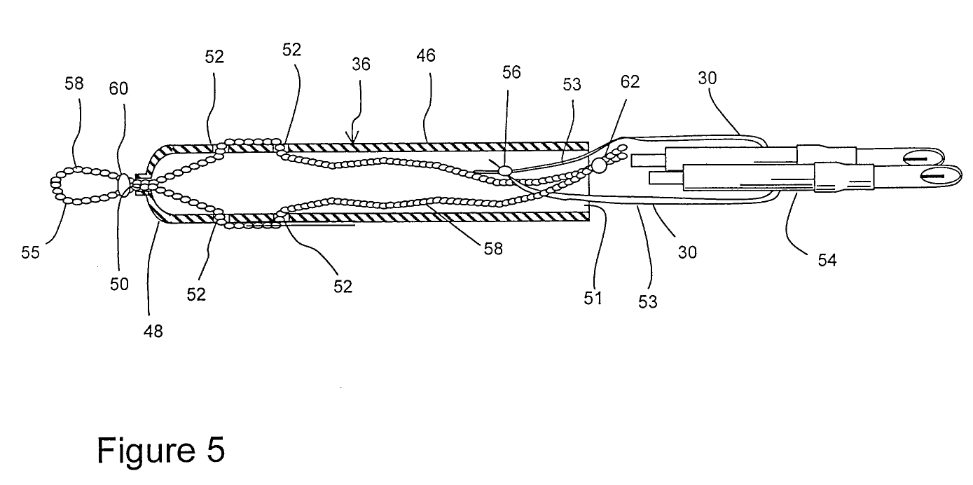

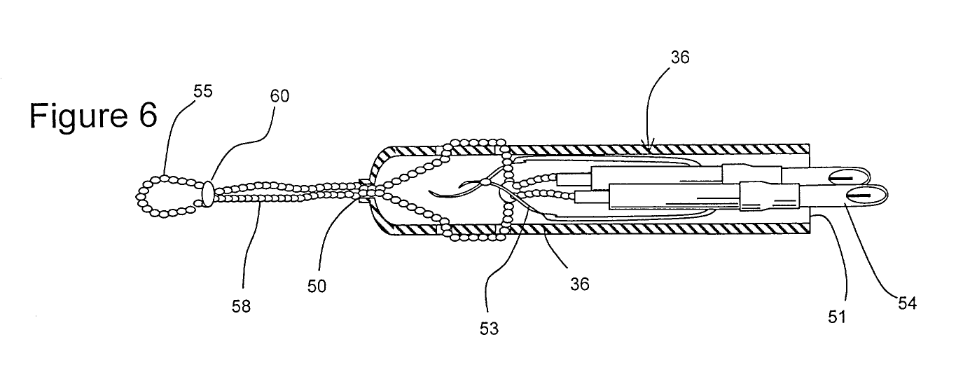

Strength member ends 30 may also be attached to pull-protector 36 in the manner shown in FIG. 5. Pull-protector 36 consists of a central cylinder 46 sufficiently large enough to contain at least one pre-terminated universal connector housing 14. Preferably, cylinder 46 is sufficiently large enough to contain several pre-terminated universal connector housing bodies. Central cylinder 46 has a closed end 48 with an opening 50, an open end 51 for receiving the pre-terminated universal connector housings 14 and a pair of opposing cylinder side openings 52. Strength member ends 30 of two universal fiber optic cable assemblies 54 are fixed together at 56 by any conventional means, thus forming a first loop 53. Rope 58 is threaded from the inside of cylinder 46 through opening 50 and fixed by a knot 60 or epoxy drop to form a loop 55 on the outside of closed end 48 and prevent it from slipping back through opening 50. The ends of rope 58 are threaded through side openings 52 and then fixed around the first loop 53 by knot 62, an epoxy drop, or similar artifice. Thus, pulling on rope 58 while holding cylinder 46 in place results in pulling the first loop and the universal cable assemblies 54 into the cylinder but not beyond the point at which side openings 52 are located, as illustrated in FIG. 6. This procedure protects the universal fiber optic cable assemblies 54 while installation is being completed by the cable being pulled through a pipe or other conduit with the pull-protector protecting the forward end of the cable while it is being pulled forward, after which the pull-protector is removed.

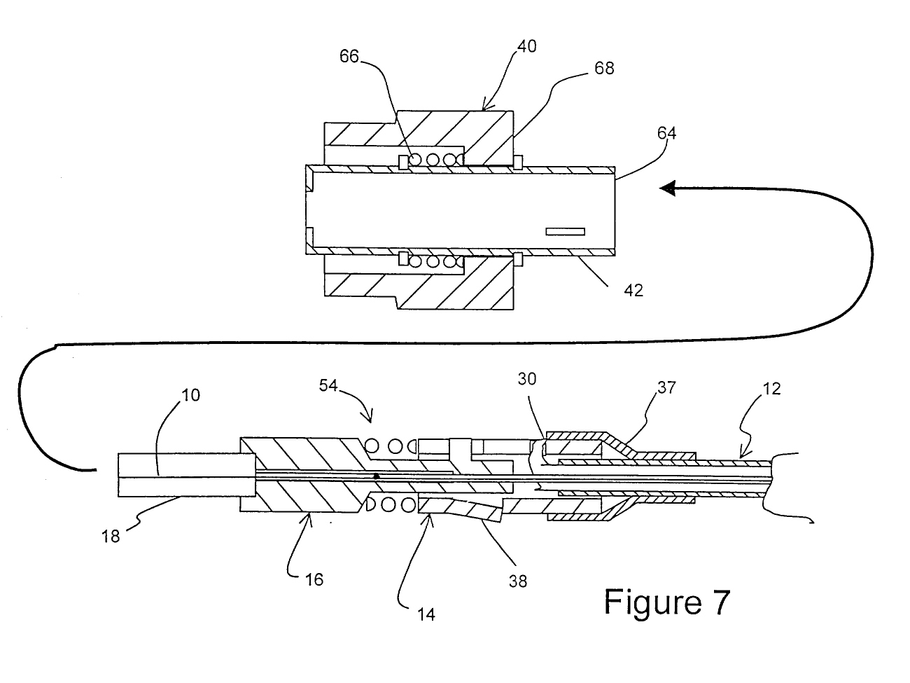

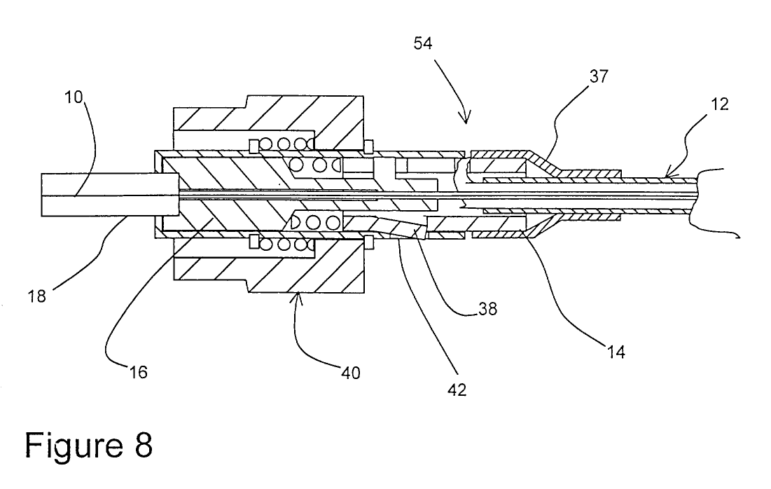

Once the universal fiber optic cable assembly 54 is terminated, for example, after having been installed in a communication duct or tray, strength member ends 30 that were attached to the pulling rope 58 of the pull-protector 36 are cut and the assembly 54 is inserted into coupling nut assembly 40, as illustrated in FIGS. 7 and 8. Upon insertion, latch 38 engages slot 42 to keep assembly 54 within coupling nut 40. Assembly 54 may then be removed by depressing latch 38 while pulling assembly 54 from coupling nut 40. Coupling nut 40 comprises hollowed out tube 64 and spring 66 within housing 68. Tube 64 has an opening at one end configured to engage assembly 54 and an opening at the other end configured to engage ceramic tip 18.

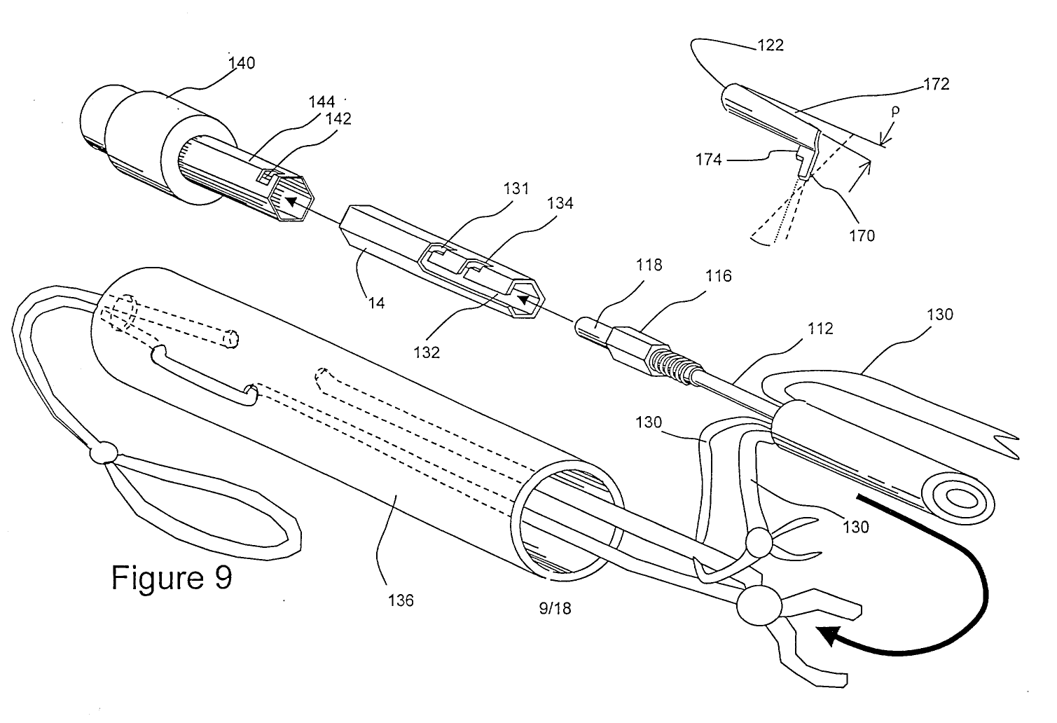

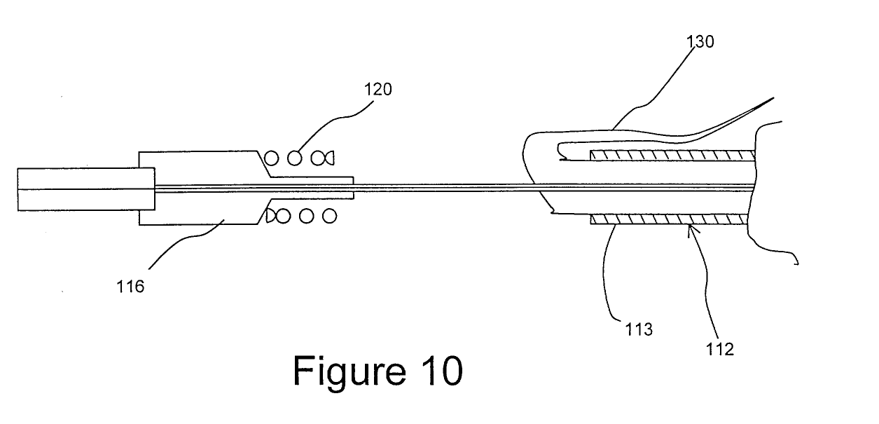

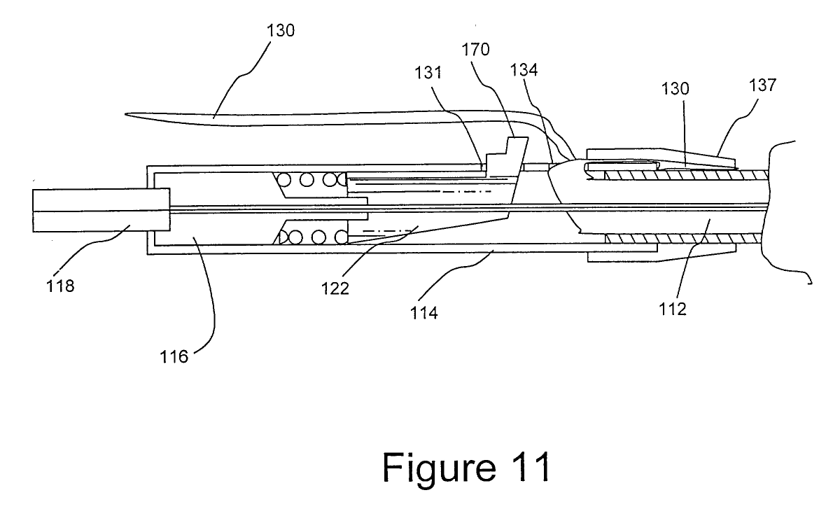

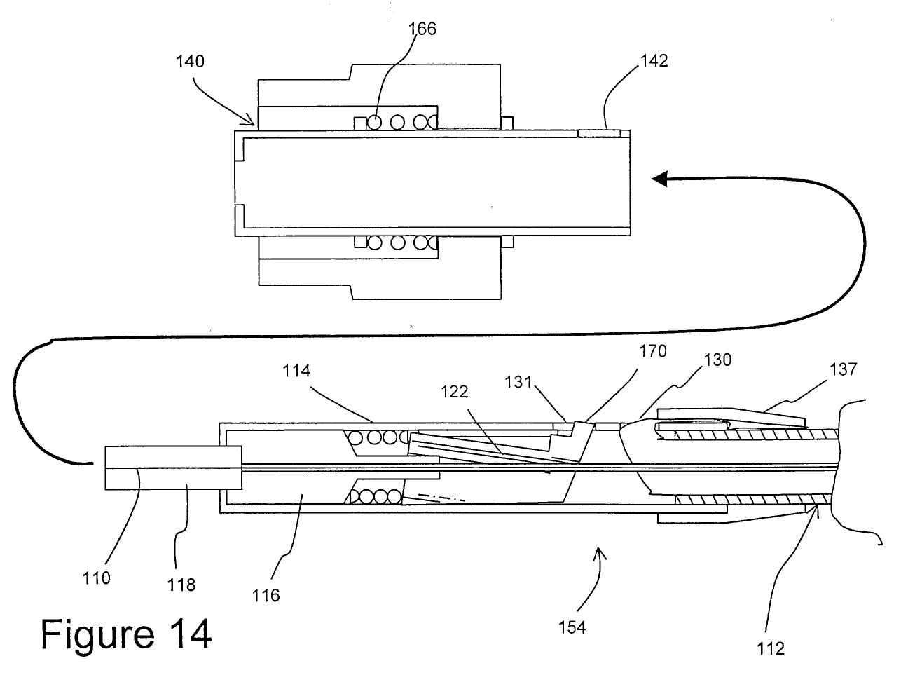

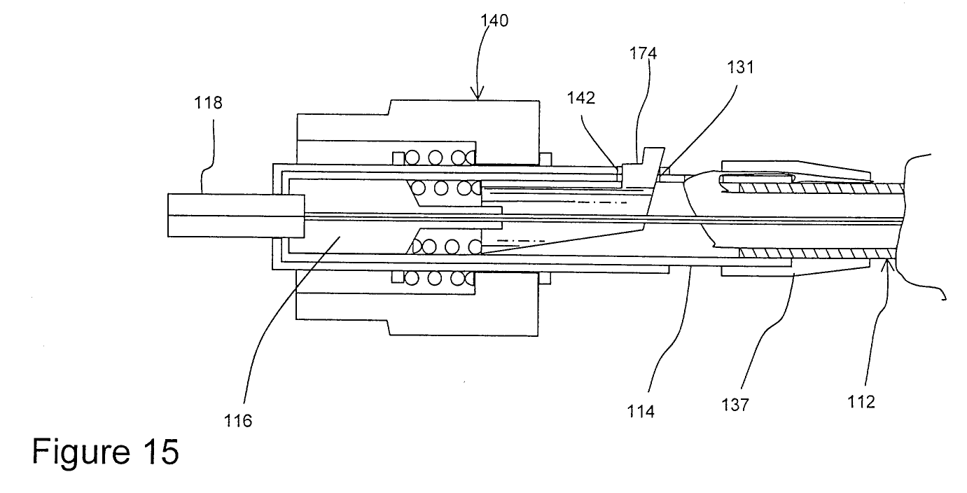

FIGS. 9-15 illustrate an alternative embodiment of the universal connector body 114 and retaining device. In this second embodiment, universal connector body housing 114 has a longitudinal groove 132 connected to two slots 131 and 134 cut out in housing 114. Slot 134 receives strength member ends 130 from fiber optic cable 112. As shown in FIG. 11, one or more of the strength member ends 130 is reserved for attaching to pull-protector 136. The second segment 44 is brought out of the new and improved universal connector body housing through slot 38 and captured on the rear of the Ferrule 116 is connected to cable 112 before being inserted into housing 114, as illustrated in FIG. 10. Retaining member 122 is a separate part which is inserted into universal connector body housing 114 to retain ferrule 116, by sliding tab 170 through groove 132 into engagement with slot 131. Member 122 has a beveled bottom 172, which permits it to be depressed inside of universal connector body housing 114 by pushing down on tab 170, thus enabling tab 170 to be inserted into tube 144 of coupling nut 140 as shown, or an adapter, and engaged with opening 142. After engagement, the lower step 174 of tab 170 is used to fill slot 131 and opening 142 to further secure the assembly and prevent relative motion between parts, as illustrated in FIG. 15. The beveled bottom 172 maintains tab 170 in a substantially upright position within slot 131 and opening 142, when not being forcibly depressed, as illustrated by arrow 176 in FIG. 14.

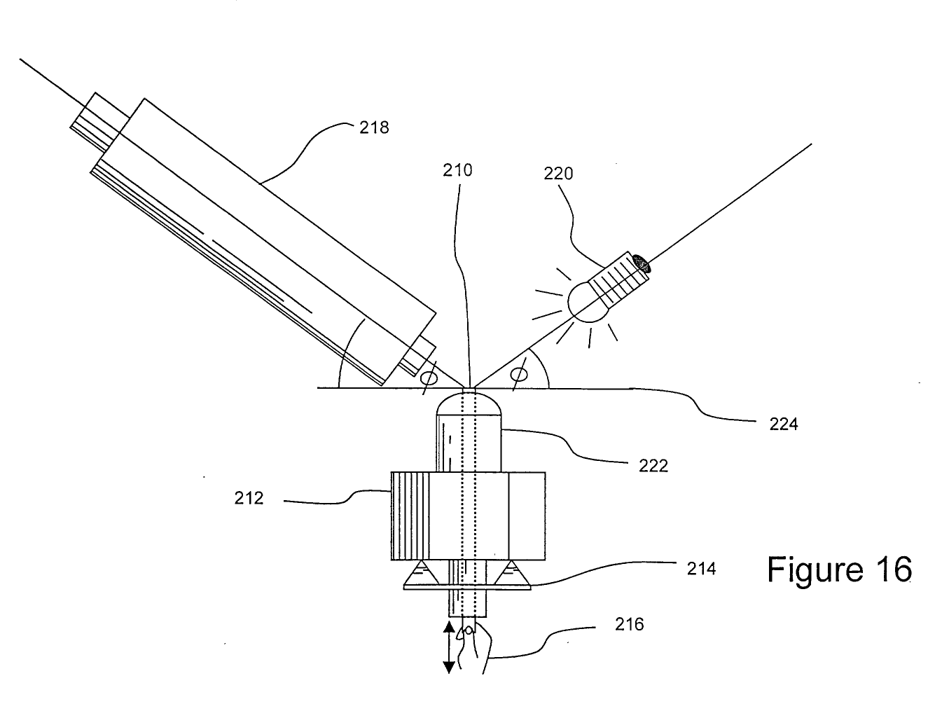

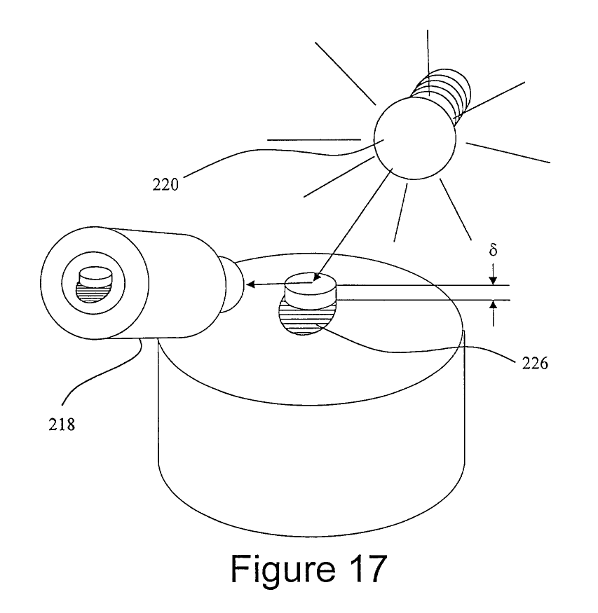

FIGS. 16-17 illustrate the method and apparatus for termination of a fiber optic cable with little or no polishing in detail. An optical fiber 210 is cleaved perpendicular to its axis to within one degree. Fiber 210 is inserted into an optical fiber connector 212 filled with a curing adhesive. The optical fiber connector 212, with fiber 210 inserted, is positioned in a termination mechanism consisting of a holder 216 (which may be the user's hand) for fiber optic connector 212, a fiber positioning device 214, a microscope 218 for viewing fiber 210, and a lamp 220 for illuminating the end of ferrule 222 and fiber 210.

Holder 216 for fiber optic connector 212 keeps connector 212 secured so that stable viewing of the protrusion of the fiber 210 in the ferrule 222 is possible. The microscope 218 for viewing fiber 210 and lamp 220 for illuminating the end-face of fiber 210 and ferrule 222 are positioned on opposite sides of fiber 210 and ferrule 222, but at the same angle φ with respect to plane 224 of the fiber end-face. This geometric arrangement of microscope 218 and lamp 220 permits the lamp light to reflect into microscope 218, thus providing brilliant illumination of the position of fiber 210 with respect to the ferrule end-face. Then, using fiber-positioning device 214, fiber 210 may be adjusted to a perfect, slightly protruded, position before the adhesive is cured. Also, the fiber end-face protrusion relative to the connector ferrule δ may be determined by comparing shadow 226 cast by lamp 220 to a graticule etched on the optics of microscope 218, as illustrated in FIG. 17.

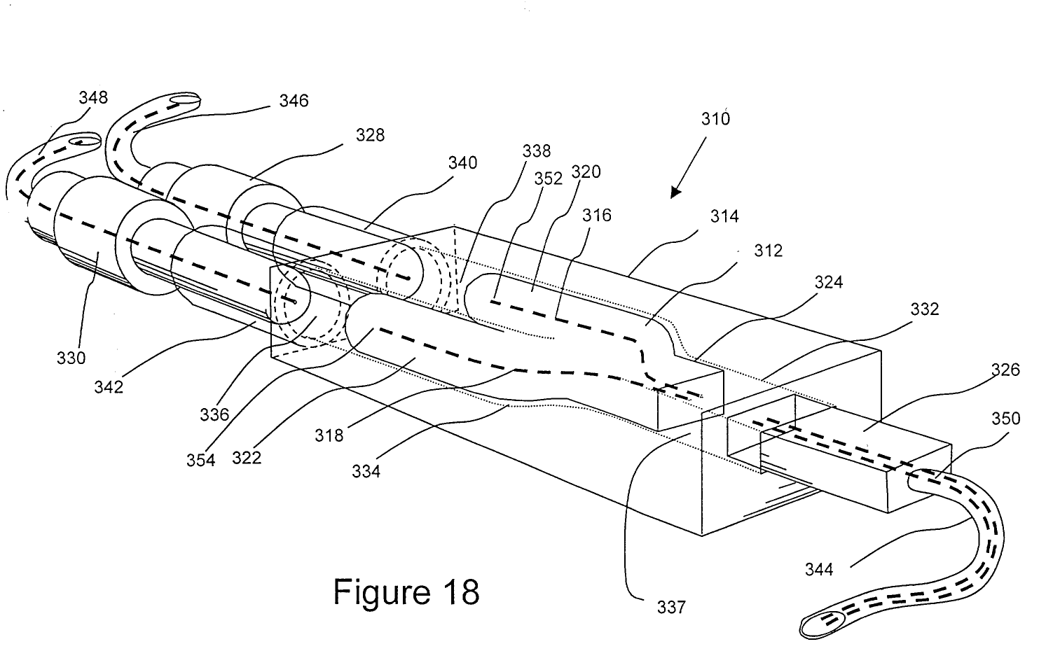

Reference is now made to FIG. 18, which illustrates an adapter 310, which may be used with the inventive universal housing 14 or 114, for mating fiber optic cables and components. Adapter 310 comprises a fiber carrier or conduit 312 inside a housing 314. Fiber optics channels 316 and 318 which permit light to travel through adapter 310 are contained within conduit 312. Conduit 312 spans housing 314, having two ends 332 and 334. Fiber optics channels 316 and 318 terminate in duplex connector interface 324 near end 332, and extend separately and terminate in two ferrule legs 320 and 322 near end 334, thus creating spaces 336, 337 and 338 in conduit 312 within housing 314. Spaces 336, 337 and 338 have coupling and retaining devices for securely mating components within housing 314. The coupling and retaining devices may be any conventional device, such as a snap-fitting engagement or retaining devices previously discussed and illustrated in FIGS. 1 and 9, that is, such as the latch 38 or tab 170 and corresponding slots 42 and 142, respectively. Spaces 336, 337 and 338 also allow conduit 312 to slide longitudinally within housing 314 to protect ferrule legs 320 and 322 and duplex fiber optic connector interface 324 from the force applied when mating adapter 310 with other components.

A duplex connector 326, connected to a duplex or multi-channel fiber optic cable 344 having fibers 350, is inserted into housing 314 to connect with interface 324. Thus, when connector 326 is mated with interface 324, light from fiber optic channels 316 and 318 is able to travel through connector 326 and into fibers 350 of cable 344.

Generic coupling sleeves 340 and 342 of two single-channel fiber optic connectors 328 and 330, respectively, are inserted into conduit 312 at end 334 to connect with legs 320 and 322, thus permitting light to travel through fiber channels 316 and 318 into cables 346 and 348. Ferrules 320 and 322 are sufficiently spaced to allow proper mating with individual single channel fiber optic connectors 328 and 330.

Fibers 316 and 318 are polished or otherwise suitably prepared so as to enable a low-loss connection at points 352 and 354 and at interface 324. The polishing process enables the light traveling in the fibers of one connector to pass, with low attenuation, to the fibers of the mating connector. Typically, manufacturers of duplex connectors employ close spacing of fibers to enable the duplex connector to maintain a compact width and height.

Adapter 310 may also be configured for alternative formats of fiber cables, such as the 0.75 millimeter fiber separation characteristic of the MT-RJ connector interface. Ferrules 320 and 322 may be of the simplex 2.5 mm diameter type, which is characteristic of the ST, FC and SC connector interfaces and other connector types. Furthermore, adapter 310 may also be connected to the universal fiber optic connector of U.S. Pat. Nos. 4,711,517 and 5,253,315 and to the MT-RJ connector without employing expensive jumper cables.

The invention also provides a termination kit comprising a number of items useful for cable assembly termination in the field or factory. The termination kit may include some or all of: a termination station to be described in more detail below; a high precision optical fiber cleaver capable of making a substantially clean cut within about degree of perpendicular to the fiber axis, for example a model CT-04B cleaver available from Alcoa Fujikura (Tokyo, Japan), a cleaver inspection microscope and a cleaver backlight. In addition, the termination kit may include one or more suitable tools for example, a jacket stripper, cutters for the fibrous or fabric strength material, buffer strippers, e.g Sumitomo model JR-22 strippers, round cable slitter and a polishing puck and plate as well as one or more supplies such as a fast-acting adhesive, for example a 3-minute epoxy adhesive, wipes, swabs, isopropyl alcohol, 1 micron or other suitable grade of diamond buffing paper and a water bottle.

Referring to FIG. 19, there are shown a plurality of individually jacketed single-fiber cables 400 extending from a fiber optic cable reel 402 to a cable cleaver 404 and a plurality of termination stations 406. Each termination station 406 comprises a cable clamp 408 to position the cable, a microscope 410 to view the cable end and suitable supports and guides, indicated generally at 412, for the stripped cable end and the connecting hardware. As described below, while single fiber cables are shown and utilized at the cleaver 404 and the termination stations 406, if desired, dual or multi-fiber cable may be provided on the cable reel 402. Preferably, each fiber of such dual or multi-strand cable is individually buffered and encased in a strength member, the dual or multiple strands being surrounded by a common jacket. The dual or multi-strand cable, if employed, can be drawn from the cable and then be separated to provide individual fibers for cleaving and termination, which operations may, for example, be done manually.

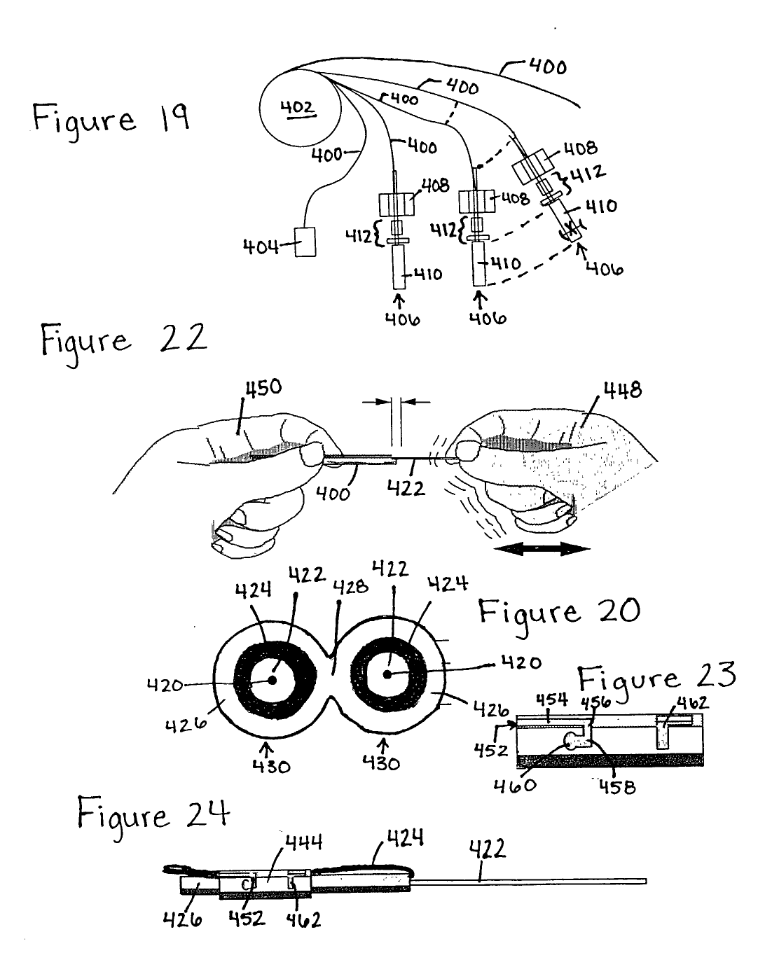

One suitable fiber optic cable that can be terminated by the method of the invention is a dual fiber zipcord cable such as is available from Corning Cable Systems' Hickory, NC USA and other suppliers and is illustrated in FIG. 20. The dual fiber zipcord cable shown in FIG. 20 comprises two optical fibers 420 each of which is surrounded by its own buffer 422, the buffered fiber being in turn encased in an aramid yarn strength member 424, e.g. of KEVLAR (trademark of E. I. du Pont De Nemours and Company) fabric and sheathed in a flexible flame retardant jacket 426 having a separable seam 428 which joins the two encased buffered fibers providing a pair of what may be termed “zipcord channels” 430. According to the manufacturer, the Corning dual fiber zipcord cable meets the application requirements of the National Electrical Code® (NEC® Article 770) and is listed as Type OFNP and CSA FT-6. Such zipcord cable is suitable for interconnect applications within plenum areas. Other suitable fiber optic cables, as known to those skilled in the art may be employed.

For low-volume production a single termination station 406 may be sufficient. For higher volume production two or more termination stations 406 can be employed enabling an operator to begin second and third or more terminations while the adhesive employed in a first termination is curing. In this way, one operator may effect one termination every two to three minutes, or quicker, after the cable is prepared.

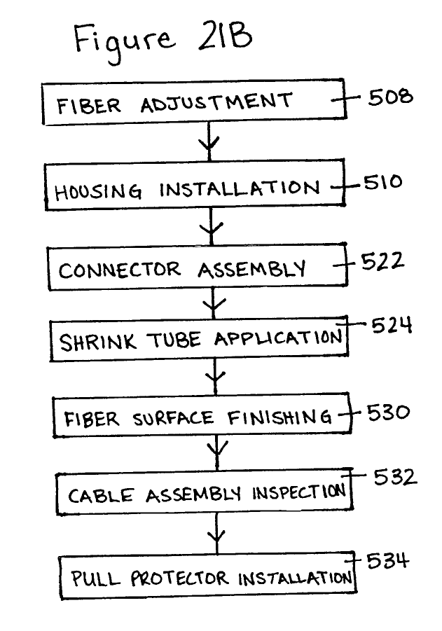

The cable termination method of the invention illustrated in FIGS. 19-37 can be performed in a series of steps, some embodiments of which will now be described.

The method preferably employs a termination kit such as described above together with a ferrule holder, a ferrule, a universal housing, a shrink tube of suitable size, for example about 300 mm by about 6 mm (about 1′ by about ¼″), a load adapter, a suitable room-temperature curing epoxy adhesive and a strip guide.

This exemplary cable termination method will be described with reference to the termination of zipcord cable employing two 900 micron fibers 420, its being understood that other sizes, qualities and configurations of fiber optic cable may be terminated by means of the inventive method, with suitable modifications thereof, if appropriate.

Referring to FIG. 21, in a preliminary step 440 of the inventive cable termination method, the cable jacket 426 is measured to verify that it is 1.6 mm in diameter, improperly sized cables being rejected.

In a following cable preparation step 442 the cable is prepared to receive a universal housing 444 (FIG. 23) by separating the two zipcord channels 430 along a suitable distance, for example about 600 mm (about 2 feet) if a pull protector is to be installed, or about 200 mm (about 8 inches) if a pull protector is not being used. Cable preparation step 442 comprises stripping the cable jacket 426 to expose at least about 380 mm (about 15 inches) of fabric strength member 424 if a pull protector is to be used, or at least about 75 mm (about 3 inches) if it is not. The exposed fibrous or fabric strength member 424 is doubled back along the cable jacket 426 to expose the buffered fiber 422. Preferably, at this point in time a shrink boot tube (not shown here) is threaded over the doubled back strength member 424 and slid up the cable 400 for later use.

The buffered cable 422 can be trimmed to a suitable length, for example to about 60-65 mm. Preferably, at this point in time a shrink boot tube (not shown here) is threaded over the doubled back strength member and slid up the cable for later use.

After the cable 400 is prepared it is desirable to ensure that depression of the assembled universal connector's spring-loaded tip will not buckle the fiber 420. To this end, the inventive method preferably comprises cable play checking step 446 illustrated in FIG. 22. In step 446, the operator grips the buffered fiber 422 in one hand 448 and grips the jacketed cable 400 in the other hand 450 and verifies that the buffered fiber 422 will move in and out of the jacket 426 a suitable small distance, typically less than about 6 mm, for example at least about 2 mm, more preferably about 2.5 mm (about 0.10 inch). Cable 400 that does not allow the buffered fiber 422 to move adequately in and out of the cable jacket 426 is preferably not employed for termination.

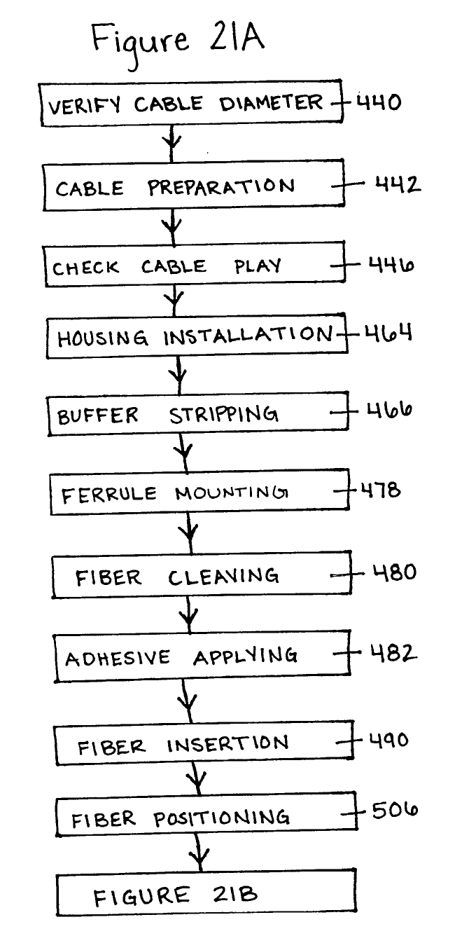

Referring to FIG. 23, the universal housing 444 shown is formed from hollow hexagonal stock material, e.g. steel stainless steel, a lightweight aluminum alloy or a tough rigid plastic and comprises strength member retaining structure and ferrule holder retaining structure. The strength member retaining structure comprises a hook-shaped strength member retaining opening 452 having an axial entry slot 454 opening into the lefthand end of the universal housing 444, a short transverse portion 456 and a short blind axial portion 458 terminating in a strength member retaining hole 460. The ferrule holder retaining structure comprises a blind-ended L-shaped ferrule retaining opening 462 one leg of which extends axially and the other transversely of the universal housing 444. Ferrule retaining opening 462 opens into an internal axial groove, as may better be seen in FIG. 30, to provide a U-shaped locking channel.

While other relative dimensions may be used, the strength member entry slot 454 preferably extends for somewhat less than half the axial length of the universal housing 444, for example from about 20 to about 45 percent of the length of the universal housing 444, and the ferrule retaining opening 462 preferably extends for from about 10 to about 30 percent of the length of the universal housing 444, for example about 20 percent. Preferably also, there is an axial separation between strength member retaining opening 452 and ferrule retaining opening 462 of from about 10 to about 50 percent of the axial length of the universal housing 444, more preferably from about 25 to about 40 percent of that length.

After a cable 400 has been checked for play in step 446, the universal housing 444 is installed, in housing installation step 464 illustrated in FIG. 24, by sliding it over the prepared buffered cable 422 and doubled back strength member 424, with the fabric strength member 424 entry slot toward the fabric strength member 424.

Referring to FIGS. 25-26, in the next step of the inventive method, buffer stripping step 466, prior to stripping, the buffer is marked with a first mark 468, preferably extending entirely around the buffered cable 422 to be visible from all sides and indicating a desired “in” position, and a second mark 470 indicating a desired “out” position, referring to the limited movement, or play, of the buffered cable 422 into and out of the cable jacket 426. Second mark 470 is used to verify positioning of the universal housing 444 in a subsequent step.

Arrow 472 in FIG. 25 indicates that the buffered cable 422 is pulled out of the cable jacket 426, while arrow 474 in FIG. 26 indicates that the buffered cable 422 is pushed back into the cable jacket 426.

After marking, a length of buffer is stripped from the cable 400 using suitable strippers, e.g the Sumitomo model JR-22 strippers mentioned above, to expose a length a of optical fiber 420 and leave a length b of buffered cable 422. Length a is chosen to provide a small excess of fiber 420 that can be cleaved to the desired length, as will be described. Length b is selected according the dimensions of universal housing 444 and the ferrule so that mark 470 will be visible in strength member opening 452 when final assembly is properly completed.

In one embodiment, the optical fiber length a is from about 10 to about 50 mm, for example about 32 mm (about 1.25 in). The buffered cable length b is preferably from about 10 to about 40 mm, for example about 19.3 mm (about 0.76 in) in the pulled out FIG. 25 position and from about 8 to about 35 mm, for example about 16.7 mm (about 0.66 in) in the pushed in FIG. 26 position. Distance d, the distance between the two positions, is the play measured in step 446, which is, as stated, preferably at least 2.5 mm (0.010 in). After stripping, optical fiber 420 is wiped clean, for example with a lint-less cloth soaked in alcohol.

At any convenient moment, for example immediately after step 466, a ferrule 476, similar to ferrule 116 is made ready in ferrule mounting step 478 by inserting the ferrule 476 into a support in a cable termination station 406, in front of a microscope 218, as will be described in more detail in connection with FIG. 28.

With the cable 400 marked and stripped in step 466, the fiber 420 is cleaved in fiber cleaving step 480 using a commercially available cleaver (not shown), for example, the model CT-04B cleaver available from Alcoa Fujikura mentioned above. The bared 900 micron coated fiber 420 is cleaved to a precise desired length projecting from buffer 422, for example 14 mm., by inserting the fiber 420 into the cleaver with the end of the buffer 422 positioned at a 14 mm marking on a scale on the cleaver. The desired cleaved length is determined, or predicted, by reference to the configuration and dimensions of ferrule 476 and is selected to provide a minimum fiber projection from the ferrule end face when the buffered cable 422 is fully inserted into the ferrule 476, as shown for example in FIG. 7 or 10 where the buffered cable can be seen to extend inside the ferrule 16 or 116 with the buffering abutting the inner face of ceramic tip 18 (FIG. 7 only) while the bared fiber 10 extends through the ceramic tip. The maximum desired cleaved length is determined by the extent of possible adjustment of the positioning of the buffered fiber 422 in the ferrule 476, as will be more apparent hereinbelow.

Cleaving is effected substantially perpendicularly to the fiber axis, preferably to at least within one degree, more preferably to within one half or even one tenth of a degree. It is desirable that cleaving be as clean, true and as near to perpendicular as practical limitations will permit to provide a high quality end face that will minimize optical losses or distortions when the end face is butted with another fiber end face. In practice a small deviation from an absolute perpendicular will occur, owing to the limitations of the cleaving equipment and the operator. The extent of deviations that can be accommodated can be determined by performing standard optical transmission tests, as referenced hereinbelow.

The cleaver manufacturer's instructions are followed using a suitable cleave plate, for example a number 7 plate. The cleaver anvil is lowered and the cleaver's fiber breaking button is depressed, cleaving fiber 420 to the desired length. The cleaver is left closed while the cleaved fiber profile is inspected under a microscope as described with reference to FIGS. 16-17.

In the next step, adhesive applying step 482 a small amount of a suitable adhesive that will cure rapidly at room temperature, preferably in less than about 30 minutes, for example a 3-5 minute epoxy adhesive, is mixed, if necessary, and applied to the bared fiber 420, preferably approximately as shown in FIG. 27. As shown, the adhesive 484, is applied in a thick coating over and around the end of the exposed fiber 420 covering substantially the whole exposed length save for a small uncoated portion 486 adjacent the cable buffer 422.

While the adhesive is still wet or tacky, i.e. before it dries, the adhesive coated fiber 420 is inserted into the ferrule 476 at the cable termination station 406, in fiber insertion step 490, as shown in FIG. 28 until the fiber 420 just barely protrudes from the ferrule end 488. Any excess adhesive is wiped from the rear of the ferrule 476. Referring to FIG. 28, cable termination station 406 comprises a support 492 which carries a ferrule feed-through member 494, preferably of a suitable plastic material, which has a transverse opening (not shown) through which ferrule end 488 can be inserted and juxtaposed to microscope 218. Ferrule 476 is longitudinally movable in feed-through member 494 up to the point where its central hexagonal portion, marked by the reference lead line, engages with the feed-through member 476.

Microscope 218 is supported in a suitable position to view the fiber 420, as described in relation to FIGS. 16-17. Cable termination station 406 further comprises a fiber positioner 496 movable along a screw member 498 secured to support 492 against a compression spring 500, by rotation of a knurled positioner knob 502. Fiber positioner 496 includes a grip 504 to receive and locate the cable jacket 426, which may comprise for example, a suitably dimensioned slot or groove (not shown) running in the cable direction. If desired the cable 400 may be additionally secured, for better handling and control of the cable, by a cable clamp provided just upstream (to the left in FIG. 28) of the cable termination station 406. Other mechanisms, e.g. lever and/or powered mechanisms may be employed to support cable 400 and ferrule 476 while permitting precise adjustment of the position of fiber 420 in ferrule 476. For example a stepper motor could be employed to automate the positioning. Also, inspection optics could be built in to the cable termination station 406, in place of the microscope 218.

In fiber positioning step 506, which is preferably conducted after the ferrule 476 has been charged with adhesive and before the adhesive cures, the cable jacket 426 is pressed into the fiber positioner grip 504 with the end of the buffer 422 closely abutting the lefthand end of ferrule 476 and a small excess of the fiber 420 projecting from ferrule 476. While the end of the fiber 420 is viewed through the microscope 218, the fiber positioner knob 502 is rotated to bring the fiber 420 flush with the righthand end face of ferrule 476. Any excess adhesive is then wiped from the ferrule face with an alcohol-dampened swab.

The fiber 420 is then adjusted to its final position, in fiber adjustment step 508, by rotating the fiber positioner knob 502 to lift the fiber 420 to a height of approximately 5 to 10 micron above the ceramic end face of the ferrule 476 for example at about 8 um. The fiber 420 is left in this position to cure for about 15 to 20 minutes, or such other time as is appropriate for the adhesive employed, preferably, with occasional checking during the first 3 to 5 minutes, before the cure is complete, to insure that the fiber 420 has not moved.

After the adhesive has cured the cable and ferrule assembly are removed from the cable termination station 40 and the universal housing 444 is installed in housing installation step 510, as illustrated in FIG. 29.

In housing installation step 510, with the cable 400 grasped in the one hand 450 and the universal housing 444 grasped in the other hand, the universal housing 444 is carefully slid up the cable 400, in the direction of the arrow 512, until the universal housing 444 just contacts the proximal end of the ferrule 476. At the same time, the fabric strength member 424 is inserted into the fabric strength member 452 opening via the entry slot 454 (FIG. 23), as shown.

Referring to FIG. 30, the ferrule 476 has a circular section shaft 514 bearing a radially projecting square- or rectangular-sectioned retaining boss 516 and a compression spring 517. Shaft 514 and retaining boss 516 are cooperable with mating structure on the universal housing 444 comprising a circular bore 518 and an entry slot 520. Entry slot 520 opens into ferrule retaining opening 462 to provide a U-shaped locking channel into which the ferrule retaining boss 516 is received.

To assemble the connector, in connector assembly step 522, the universal housing 444 is slid onto the ferrule 476, in the direction of the arrow 524, and the ferrule retaining boss 516 is inserted into the connector housing entry slot 520. Once inside the entry slot 520, the universal housing 444 and ferrule 476 are pushed together, depressing compression spring 517 and allowing the retaining boss 516 to move along the entry slot 520. Universal housing 444 is then rotated clockwise, moving retaining boss 516 into ferrule retaining opening 462, where it is held in place by the action of spring 517, once the assembly is released from the hands of the operator.

Ferrule 476 which is adhesively secured to buffered cable 422 and universal housing 444 which is adhesively secured to strength member 424 are securely locked against relative rotational movement by engagement of retaining boss 516 into ferrule retaining opening 462. Furthermore, ferrule 476 and universal housing 444 are resiliently secured together in a manner preventing relative axial movement apart, also by engagement of retaining boss 516 into ferrule retaining opening 462, and permitting only limited axial movement towards each other against the action of compression spring 500.

The assembly is prepared for the application of a shrink-tube boot, in shrink-tube application step 524 by depositing a small amount of fast-cure adhesive 526 to secure fabric strength member 424 and the boot to the cable 400 and universal housing 444. If a pull protector is to be installed, the strands of fabric strength member 424 are separated for example by being split in half so that one half 424A can be used to install the pull protector, the other half 424B being secured to the cable 400.

Next, the fabric strength member 424 and cable jacket 426 are carefully pulled back to expose first mark 470 on buffer 422. Fabric strength member 424 is seated in strength member retaining opening 452, with sufficient tension to keep it seated, preferably with a drop of adhesive being applied.

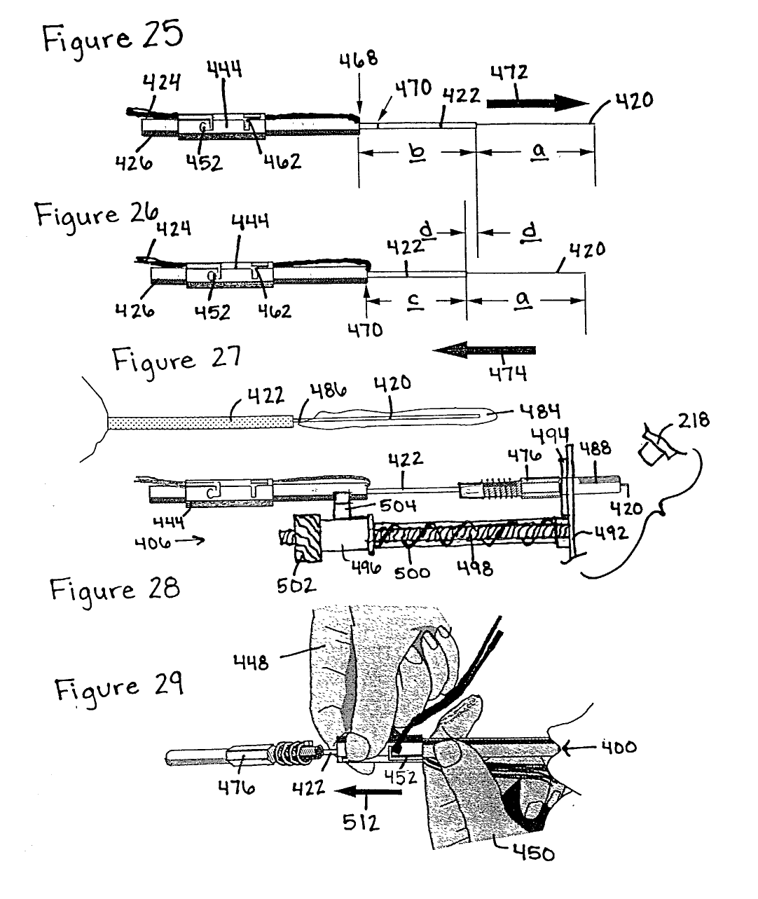

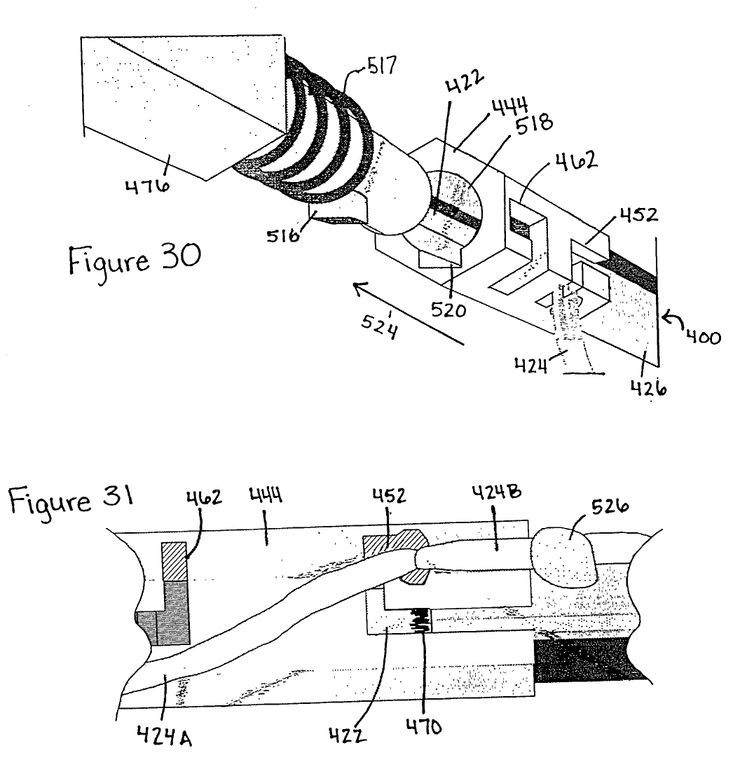

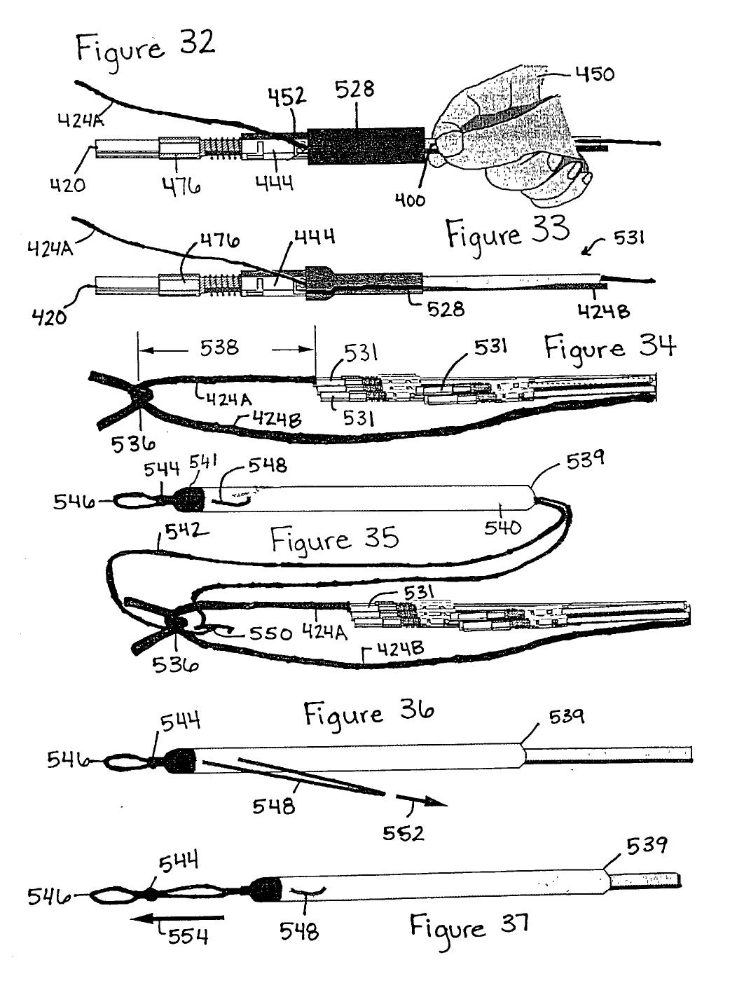

Referring now to FIGS. 32-33, while holding fabric strength member 424 in retaining opening 452, a shrink tube boot 528 of suitable size, for example about 25 mm long by about 6 mm diameter (about 1 in by ¼ in), that was preferably threaded on cable 40o in cable preparation step 442, is slid along cable 400, over the righthand end of universal housing 444, to just below fabric strength member retaining opening 452. Using a heat gun, just enough heat is applied to boot 528 to shrink it around cable 400, as shown in FIG. 33, securing the assembly. Excess adhesive is wiped off and the fabric strength member 424 can be cut to length, for example at the right hand end of boot 528, after setting of the adhesive, which is preferably also a fast-cure epoxy.

After cleaving fiber 420, by the method of the invention, as described above in fiber cleaving step 480, inspection of the fiber end with a microscope will usually reveal surface irregularities that may cause mating problems but which can be smoothed away in a simple finishing operation.

Once the epoxy has cured, the surface of fiber 420 can be finished in a fiber surface finishing step 530 having the following steps:

1. A 1 micron polishing film is placed on a polishing plate, dull side up.

2. One drop of water is applied to the film.

3. The assembled connector is inserted into the polishing puck and place on the wetted polishing film.

4. While applying light pressure to the connector, the polishing puck and the connector are moved in a figure-of-eight for two cycles only.

5. The assembled connector is removed and placed in the cable termination station 406 for viewing and inspection through the microscope 218.

The previously rough surface should be smooth and shiny. If necessary, finishing step 530 may be repeated. Preferably, no further polishing, grinding or other material removal from the fiber 420 is necessary. Thus, the end of the fiber 420 is finished and ready to butt flush with another comparably finished fiber end, with very little polishing and with no significant or even no detectable length changing material removal.

Preferably the resulting cable connector assembly 531 is carefully inspected in cable assembly inspection step 532 for a number of parameters before being deployed, or before applying a pull protector, if employed. Some desirable test criteria that should be met, failing which one or more of the above-described cable termination steps is repeated or the cable assembly should be discarded, are as set forth in the following table:

| Test type | Test description | Test requirements |
|---|---|---|
| Appearance | Inspect for adhesive | No adhesive stains, soiled areas; |
| | stains, soiled areas, | boot application should be neat. |
| | boot condition. | |
| Insertion loss | EIA/TIA | Requirement is 0.75 db. max. |
| | FOTP-171* | |
| | Test at 1300 nm | Objective: 0.5 db max.; |
| | | example 0.2 db |
| Backreflection: | EIA/TIA | Requirement is |
| | FOTP-107** | 20 db min. |
| multimode | Test at 1300 nm | |
| Backreflection: | EIA/TIA | Requirement is 26 db min. |
| | FOTP-107** | |
| single mode | Test at 1300 nm | Objective: 40 db min.; |
| | | example 43 db. |

*Electronic Industries Association/Telecommunications Industries Association Fiber Optic Test Procedure 171
**Electronic Industries Association/Telecommunications Industries Association Fiber Optic Test Procedure 107

If a pull protector is to be used, it may be installed by a procedure similar to that described hereinabove in connection with the embodiments of the invention illustrated in FIGS. 1-8 and 9-15. To this end, in a pull protector installation step 534, as shown in FIG. 34, a number of cable connector assemblies 531, for example from 2-25, preferably from 3-10, are grouped together. A secure knot 536 is tied in the two halves 424A-B of the fabric strength member 424 of one of the cable connector assemblies 531. Knot 536 is located a suitable distance 538, for example 20 to 75 mm, beyond the longest connector group and is formed so as to fit into a pull protector.

As shown in FIG. 35, a suitable pull protector 539 comprises a tubular body 540 closed at one end by an apertured end cap 541 through which one end of a pull protector rope 542 passes. The one end 542 of the pull protector rope 542 carries a knot 544 defining a first loop 546, knot 544 serving to prevent loop 546 from being drawn back into the pull protector 539. Rope 542 is threaded through two holes in tubular body 540, near end cap 541, to define a second loop 548.

The pull protector rope 542 is passed through the fabric strength member 424 loop and tied by a secure knot 550 dimensioned to fit into the pull protector. Excess pull protector rope 542, knots 536 and 550 and finally the cable connector assemblies 531 are pulled into the pull protector by pulling the second loop 548 in the direction of the arrow 552, as shown in FIG. 36.

When the cable connector assemblies 531 are safely pulled into the pull protector, the excess pull rope 542 is drawn out of the pull protector end cap 541 by pulling first loop 546 in the direction of arrow 554, as shown in FIG. 37. If desired, the pull protector assembly can be coiled on a reel, or tied into a coil, whereupon it is ready to be installed.

One drawback of many prior art cable termination methods is that they require a cut or break in the glass fiber to be made while the fiber is mounted in a ferrule. This is a difficult procedure wherein a relatively long length of fiber must be projected from the ferrule. The fiber is mounted in the ferrule with adhesive and the adhesive is cured in an oven, possibly overnight, to ensure a very solid lock between the fiber and the ferrule. Then fiber projecting from the ferrule is scribed and broken off, or cleaved resulting in a rough end. The rough end is polished or groung down and the ferrule itself may also require grinding down to remove roughness or even shards of the fiber. These and other steps may be necessary to obtain an accurately perpendicular flat end face.

In contrast, the devices and methods of the present invention permit the fiber 420 to be cleaved before it is assembled to the ferrule 476. Accordingly, there is sufficient space for employment of a commercial cleaving machine enabling accurate cleaving of the end face within at least one degree of perpendicular, and enabling a satisfactory end surface to be obtained without significantly displacing the end face by material removal with grinding or polishing down.

The invention enables a suitable cleavage point to be predicted, measured and marked before assembly with the ferrule 476 and provides for the length of fiber 420 projecting from the ferrule 476 to be adjusted to a precise position, relative to the ferrule, after assembly, in fiber positioning step 506. Because the fiber can be cleaved before it is inserted in the ferrule, there is plenty of space available. A long length of fiber 420 can be used and fitted in a commercial cleaver avoiding cutting or breaking the fiber 420 while it is mounted in a ferrule 476.

Furthermore, using a microscope 218, pursuant to the invention, the fiber 420 can be adjusted to an optimal position and if necessary just lightly polish it to give the end face a good finish. Polishing machines are not generally required in the methods of the invention. Nor is a heat curing adhesive required. A room temperature curing adhesive is sufficient because the fiber 420 does not have to be pressured axially with a polishing machine. The cleaved length can be the ferrule-contained length plus a small projection plus a small allowance for adjustment, for example approximately 1 to 1.3 mm beyond the length of bare fiber 420 extending within the ferrule 476 when a buffered cable 422 is fully inserted. The invention provides an easy and simple cable termination process.

Furthermore, the configurations of universal housing 444 and ferrule 476 are compact, especially transversely of the cable length or axis, having only a modestly greater girth than the jacketed cable 40 itself. Such compactness is particularly advantageous where multiple fibers are to be terminated and furthermore are to be pulled through municipal or building or other structural conduits.

In summary, the invention provides a fiber optic cable termination method comprising:

a) determining a desired final length of bared optical fiber suitable for termination with a specific ferrule;

b) stripping the fiber optic cable to expose a length of buffered cable;

c) stripping the buffered cable length to expose an excess of bared fiber optic cable beyond the desired final length;

d) cleaving the bared fiber optic cable to the desired final cable length substantially perpendicularly to the fiber axis, optionally employing a cleaving machine comprising an anvil, a clamp and a slidable rotary blade;

e) inserting the cleaved fiber into a ferrule;

f) applying adhesive to secure the fiber in the ferrule; and

g) adjusting the position of the fiber in the ferrule to have a desired length of projection from the ferrule prior to solidification of the adhesive.

Preferably, the fiber position adjustment is effected using a cable termination station which holds the cable and ferrule and permits controlled adjustment of the fiber position by operation of a control mechanism, for example a rotatable drive. After adjustment, the fiber and ferrule can be left at the cable termination station while the adhesive cures.

While illustrative embodiments of the invention have been described above, it is, of course, understood that various modifications will be apparent to those of ordinary skill in the art. Many such modifications are contemplated as being within the spirit and scope of the invention.

1. A fiber optic cable connector device for connecting to a fiber optic cable end portion, the connector device comprising:
a) a housing having an axial bore, a first end for receiving a fiber optic cable end portion and a second end for exposing the fiber optic cable end portion the fiber optic cable being securable to the housing;
b) a ferrule having an axial bore permitting said fiber optic cable end portion to be inserted through said ferrule, a first end for exposing the fiber optic cable end portion and a second end couplable with said housing;
(c) a resiliently compressible retaining device for connecting said housing with said ferrule to permit limited axial movement between the ferrule and the housing, said retaining device comprising locking components of said housing and said ferrule, said locking components being interengageable to axially retain the ferrule to be connected to the housing;
wherein when said locking components are interengaged, said housing and said ferrule are locked against relative rotational movement.

2. A device as claimed in claim 1, wherein the housing and the ferrule both have polygonal, optionally hexagonal, external cross-sections and in that the connector device further comprises a coupling member having an axial bore with a polygonal internal cross-section corresponding with the external cross-sections of the housing or the ferrule or both, for receiving and securing a coupled ferrule and housing said coupling member having a first end with a retaining device slidably engageable with said coupled ferrule and housing, the coupling member having a second end for receiving said second end of said ferrule and exposing the fiber end portion.

3. A device as claimed in claim 2, wherein said retaining device comprises two ramped surfaces on said second end of said ferrule engageable with a protruding member on said first end of said housing.

4. A device as claimed in claim 2 wherein said external cross-sections of said housing and said ferrule are similar in size and configuration.

5. A device as claimed in claim 1 characterized by said resiliently compressible retaining device comprising a compression spring secured to said first end of said ferrule.

6. A device as claimed in claim 2, wherein said ferrule further comprises a first smaller annular section to fit in housing and a second larger annular section to fit in said coupling member.

7. A device as claimed in claim 1, wherein said retaining device comprises interlocking male and female connector elements.

8. A device as claimed in claim 7, wherein said male connector element comprises a protruding member on said ferrule and said female connector element comprises a gripping device having an opening to lockably receive said protruding member.

9. A device as claimed in claim 8, wherein said male and female connector elements are releasably engageable.

10. A device as claimed in claim 9, wherein said gripping device has slanted ramps to facilitate insertion of said male element.

11. A device as claimed in claim 9, wherein said housing member comprises an opening to receive a cable sheath end.

12. A device as claimed in claim 1, wherein said housing member has a polygonal, optionally hexagonal, internal cross-section and said ferrule has a polygonal, optionally hexagonal, external cross-section and is a sliding fit in said housing member.

13. A device as claimed in claim 12, wherein said retaining device comprises a separate retaining member insertable into said housing to retain ferrule.

14. A device as claimed in claim 13, wherein said retaining member comprises a tab receivable into an opening in said housing member and lockable into engagement with an L-shaped slot.

15. A device as claimed in claim 13, wherein said retaining member has a shaped bottom enabling the tab to be depressed into said housing against the action of said resiliently compressible retaining device.

16. A device as claimed in claim 1 further comprising a coupling member for receiving the cable connector device and fiber optic cable end portion.

17. A device as claimed in claim 16, wherein said coupling member comprises:
a) a first annular section for receiving said cable connector device;
b) a second annular section for receiving said cable end; and
c) a further retaining device for securing the engagement of said cable connector device and said coupling member.

18. A device as claimed in claim 17, wherein said further retaining device comprises interlocking male and female connectors.

19. A fiber optic network formed by coupling multiple fiber optic cables together by multiple cable connector devices each said cable connector device being a connector device as claimed in claim 1.

20. A fiber optic cable termination station comprising:
a) a cable grip to hold a fiber optic cable;
b) a support member to support a cable terminating ferrule juxtaposed to the cable grip; and
c) an adjustment mechanism for adjusting the position of the support member relative to the cable grip;
wherein a bared fiber component of the fiber optic cable can be projected through the ferrule and adjusted in axial position with respect to the ferrule.

21. A fiber optic cable termination station according to claim 20 further comprising the cable wherein the cable has a cable jacket gripped in the cable grip, a buffered fiber extending from the jacketed cable into the one end of the ferrule and a positionable fiber extending from the other end of the ferrule.

22. A fiber optic cable termination station according to claim 21 further comprising a tubular housing for the ferrule threaded on the cable proximally from the cable grip.

23. A fiber optic cable termination station according to claim 21 further comprising a microscope for inspecting the fiber projecting from the ferrule.

24. A pull protector for multiple fiber optic cable connector devices, the pull protector being comprising an elongated housing having a first, open end to receive one or more fiber optic cable connector devices, a second end formed with an end opening and at least two opposing side openings longitudinally displaced from said end opening and comprising an endless flexible line threaded through said end opening and side openings to provide a first loop for attachment of cable sheath ends extending from said cable connector devices and a second loop projecting through said opening for attachment to a pulling device.
